(19) United States
(12) Patent Application Publication
(10) Pub. No.: US 2024/0289137 A1
(43) Pub. Date: Aug. 29, 2024

(54) DEVICE FOR MACHINE TOOL

(71) Applicant: DMG MORI CO., LTD., Nara (JP)

(72) Inventors: Seitaro TAKAGI, HOKKAIDO (JP); Kazuyuki YAMAMOTO, HOKKAIDO (JP); Takashi INOUE, HOKKAIDO (JP); Junichiro OKUNO, HOKKAIDO (JP)

(73) Assignee: DMG MORI CO., LTD., Nara (JP)

(21) Appl. No.: 18/693,107

(22) PCT Filed: Sep. 29, 2022
(86) PCT No.: PCT/JP22/36523

§ 371 Date: Mar. 18, 2024

(30) Foreign Application Priority Data
Sep. 29, 2021 (JP) 2021-158848

(51) Int. Cl. G06F 9/4401; B23Q 15/007

(52) U.S. Cl. CPC G06F 9/4406; B23Q 15/007

(57) ABSTRACT

A device for a machine tool is a device for a machine tool attachable to an attachment portion of the machine tool, and includes a processor for performing a process of booting an OS, a function portion for receiving an instruction from an application running on the OS, and a system power supply for sending power toward the processor and the function portion.

### TECHNICAL FIELD

The present invention relates to a device for a machine tool attachable to the machine tool and the like.

### BACKGROUND ART

Examples of machine tools include (i) a machine that allows a tool to be attached to a spindle and machines a workpiece with the tool, (ii) a machine that allows a plurality of tools to be attached to a turret and machines a workpiece while rotating the workpiece, (iii) an additive manufacturing machine that machines a material while melting the material by a laser, and a combined machine including these functions in combination.

In addition to machining, other functions can be performed by machine tools, such as observation of a workpiece by a camera attached to a machine tool in recent years (Patent Literature 1).

### CITATION LIST

### Patent Literature

PTL 1: JP 6656707 B

### SUMMARY OF INVENTION

### Technical Problem

Patent Literature 1 discloses a camera as a device for a machine tool attachable to the machine tool.

A time required for starting up the device for the machine tool is preferably shorter, considering that a procedure of machining a workpiece and measuring the machining is repeated. This is because the entire process is completed shorter as the time is shorter.

Therefore, a mechanism is demanded which smoothly performs the operation of the device, such as the camera.

### Solution to Problem

Accordingly, the present invention provides a device described in the claims.

### Advantageous Effects of Invention

According to the present invention, it is possible for a device for a machine tool to operate itself smoothly.

### BRIEF DESCRIPTION OF DRAWINGS

FIG. 1 is a perspective view of an example of a device for a machine tool attachable to the machine tool and can rotate.

FIG. 2 is a cross-sectional view related to an attaching mechanism and a rotating mechanism of a spindle and the device for the machine tool.

FIG. 3 is a cross-sectional view related to wires, electrical parts, and optical parts in the device for the machine tool.

FIG. 4 is a configuration diagram of a first form of a machining system.

FIG. 5 is a configuration diagram of a second form of the machining system.

FIG. 6 is a diagram illustrating an outline of a time required for startup of the device for the machine tool.

FIG. 7 is a configuration diagram of an electrical circuit board.

FIG. 8 is a diagram illustrating a flow of power immediately after a power is turned on.

FIG. 9 is a configuration diagram of embedded programs.

FIG. 10 is a diagram illustrating a flow of power and a flow of a signal after launching of software.

FIG. 11 is a diagram illustrating a flow of power and a flow of a signal when power supply to a camera is stopped.

FIG. 12 is a configuration diagram of an electrical circuit board in a first modification.

FIG. 13 is a configuration diagram of an electrical circuit board in a second modification.

FIG. 14 is an external view of the machine tool.

FIG. 15 is a configuration diagram of integrated circuits in a function unit.

FIG. 16 is a diagram illustrating another example of a procedure for starting up the device for the machine tool.

### DESCRIPTION OF EMBODIMENTS

A device for a machine tool attachable and rotatable to the machine tool and the machine tool will now be described below with reference to the drawings.

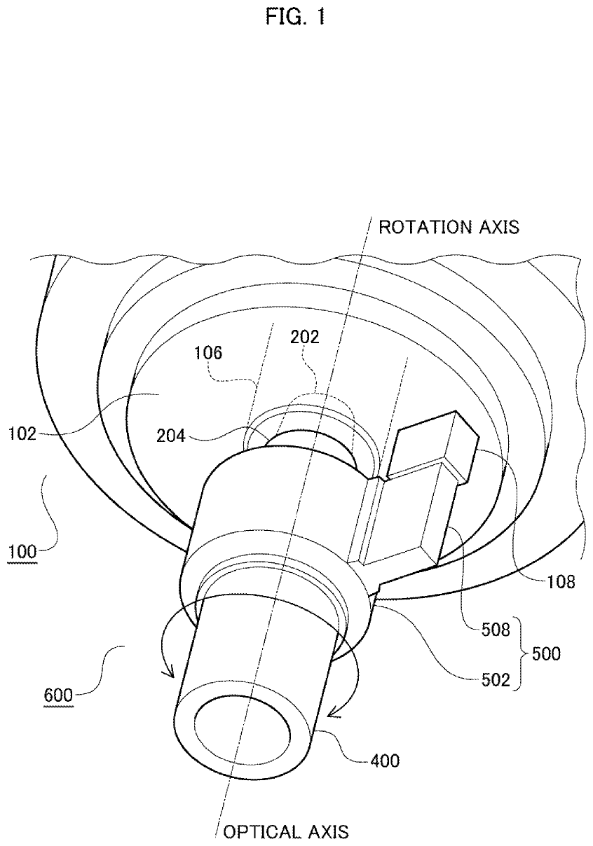

FIG. 1 is a perspective view of an example of a device 600 for a machine tool attachable and rotatable to the machine tool.

### (Outline of Device 600 for Machine Tool)

The device 600 for the machine tool is a device attachable to an attachment portion of the machine tool in a detachable and rotatable manner and fulfills a predetermined function as described later. The device 600 for the machine tool in this example is an image probe that is mounted to the machine tool and is used for imaging an image of a workpiece. Since the device 600 for the machine tool is electrically connected to the machine tool with a connector as described later, the device 600 for the machine tool can perform power feeding and communication by respective wires.

The device 600 for the machine tool has a shank 202 on the side to a spindle that is the attachment portion. The shank 202 is fitted to a spindle 106 of a machining center that is the machine tool, whereby the device 600 for the machine tool is attached to a spindle 100. An attachment manner is identical to that in a case of attaching a tool. A tool changing device of the machine tool can also grip a grip 204 of the device for the machine tool, move the device 600 for the machine tool, and attach the device 600 for the machine tool to the spindle 106.

### (Outline of Spindle 100)

The spindle 100 is an example of an “attachment portion of a machine tool” to which the device 600 for the machine tool is attached. In a case where the machine tool is a turning center, a turret corresponds to the “attachment portion of a machine tool”. The device 600 for the machine tool may be attached to the turret and be caused to image an image of a workpiece, a tool and so on. Further, the device 600 for the machine tool may be attached to a combined machine. In either case, the device 600 for the machine tool is attached to the “attachment portion of a machine tool” in a detachable and rotatable manner.

### (Outline of Function Unit 400)

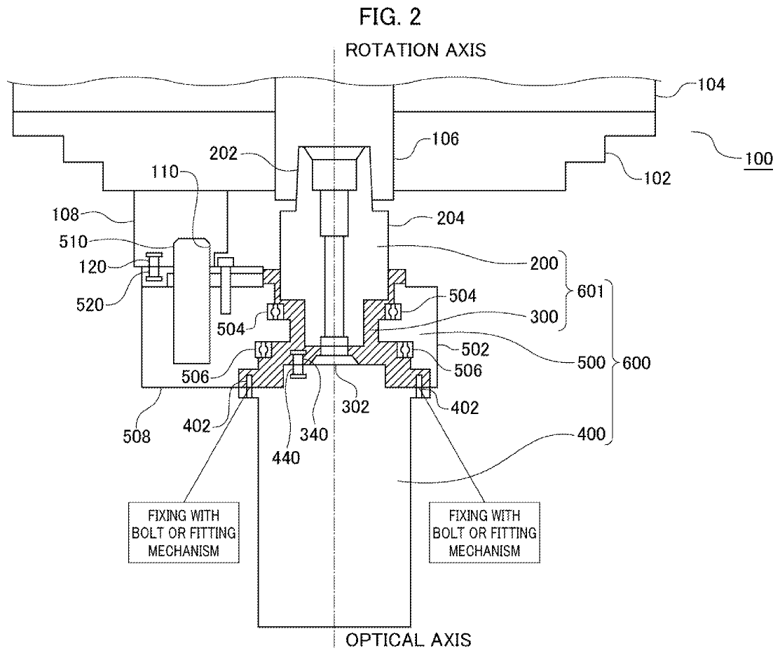

The device 600 for the machine tool includes a function unit 400 on an opposite side to the attachment side when the device 600 for the machine tool is attached to the attachment portion. The function unit 400 has a function portion that fulfills a predetermined function incorporated therein. The function portion means a portion that can perform a predetermined function (e.g., imaging, touch measurement, or laser scanning). The device 600 for the machine tool in this example has a camera incorporated therein. The device 600 for the machine tool also includes a connector (not illustrated in FIG. 1) that will be described later with reference to FIG. 2.

When the device attached to the spindle 106 partially rotates around a rotation axis in a range from 0 degree to 360 degrees, a shank portion 200, a connector 300, and the function unit 400 of the device rotate therewith, but a fixed portion 500 of the device does not rotate. Accordingly, the function unit 400 can change its orientation in a range from 0 degree to 360 degrees around an optical axis. That is, image capturing can be performed by changing in a range from 0 degree to 360 degrees. The rotation axis of the spindle 106 is a center line in the spindle 106 in the form of a cylinder. The optical axis of the function unit 400 coincides with the extended line of the rotation axis of the spindle 106 in this embodiment.

### (Outline of Fixed Portion 500)

The device 600 for the machine tool includes the fixed portion 500. The fixed portion 500 is attached and fixed to the spindle 100 (an example of the “attachment portion of a machine tool”). Therefore, when the spindle 106 rotates, the fixed portion 500 does not rotate together with a rotating portion 601 including the shank portion 200 and the connector 300. A cylindrical portion 502 of the fixed portion 500 serves as a housing that supports the rotating portion 601 while allowing rotation of the rotating portion 601. Therefore, the fixed portion 500 is arranged to surround the rotating portion 601 as viewed along the rotation axis of the rotating portion 601.

### (Outline of Locking Block 108)

The fixed portion 500 of the spindle 100 has an extension 508 protruding from a side surface of the cylindrical portion 502. The extension 508 is locked by a locking block 108 protruding from a front cover 102 of the spindle 100 (more specifically, engages with the locking block 108 to be stopped). The locking block 108 is a member that does not rotate in the spindle 100. The locking block 108 can also be referred to as a “fixed portion”, a “non-rotating portion”, or a “locking portion”. The extension 508 and the locking block 108 prevent the fixed portion 500 from co-rotating. That is, the fixed portion 500 is attached and fixed to the spindle 100 (an example of the “attachment portion of a machine tool”). A locking means will be described with reference to FIG. 2.

Further, an electrical contact means is provided in the locking block 108 and the extension 508. This contact means ensures a signal line and a power line. The contact means will be described with reference to FIG. 2. Communication and power supply in this example conform to the PoE (Power over Ethernet) standards. PoE defines the specification that allows power supply based on the Ethernet. The Ethernet is one type of standards of wired LAN (Local Area Network).

### (Rotating Parts and Non-Rotating Parts)

Rotating parts and non-rotating parts are organized. The shank 202, the grip 204, and the function unit 400 of the device 600 for the machine tool rotate in association with rotation of the spindle 106. The connector (see FIG. 2) of the device 600 for the machine tool, which will be described later, also rotates. A rotation axis of each of the shank 202, the grip 204, the connector, and the function unit 400 coincides with the extended line of the rotation axis of the spindle 106. Meanwhile, the front cover 102, a housing 104, and the locking block 108 of the machine tool and the fixed portion 500 (the cylindrical portion 502 and the extension 508) of the device 600 for the machine tool do not rotate.

FIG. 2 is a cross-sectional view related to an attaching mechanism and a rotating mechanism of the spindle 100 and the device 600 for the machine tool.

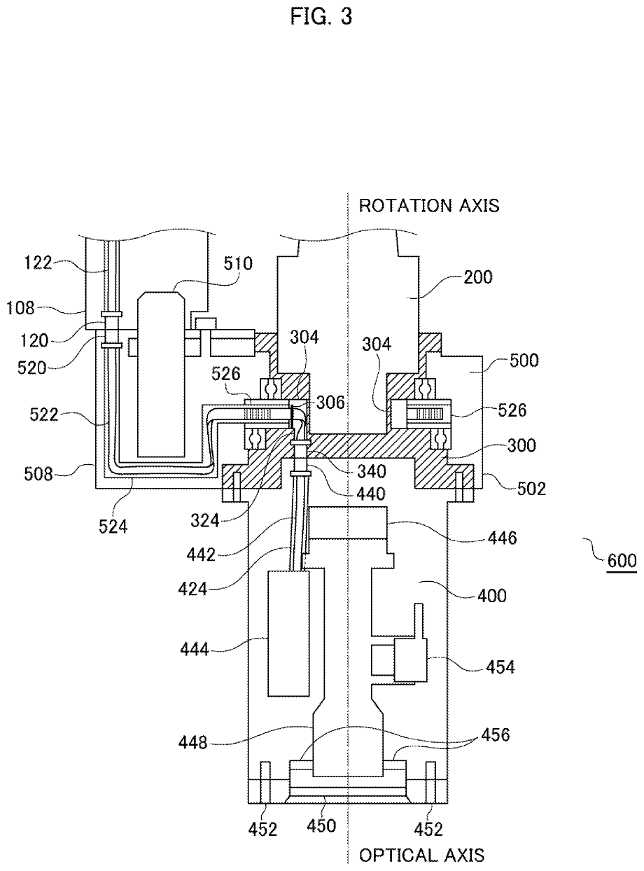

FIG. 2 mainly illustrates the attaching mechanism and the rotating mechanism, and omits an electrical configuration and an optical configuration. Wires, electrical parts, and optical parts in the device 600 for the machine tool will be described later with reference to FIG. 3.

### (Configuration of Spindle 100)

The spindle 106 is supported by the housing 104 to be rotatable and rotates by being driven by a servo motor. The front cover 102 is provided in a front-end portion of the spindle 100 and covers the housing 104. The front end of the spindle 106 protrudes through a hole in the front cover 102. The spindle 106 is rotated by the servo motor to a predetermined rotation angle, whereby the function unit 400 is aligned with a predetermined rotation angle.

### (Rotating Portion 601)

The device 600 for the machine tool is provided with the rotating portion 601 including the shank portion 200 and the connector 300. The rotating portion 601 is attached to the spindle 100 (an example of the “attachment portion of a machine tool”) to be rotatable. The function unit 400 is attached to the rotating portion 601. Therefore, the function unit 400 rotates in association with rotation of the rotating portion 601, in the same direction as the rotation direction of the rotating portion 601.

Specifically, the shank portion 200 includes the shank 202 fixed to the spindle 106 and the grip 204 to be gripped by a tool changing device. The connector 300 is fixed to the shank portion 200 with a tool-holder-attaching bolt 302. The connector 300 is supported to be rotatable inside the fixed portion 500.

The function unit 400 is fixed to the connector 300 with a bolt 402. Therefore, the function unit 400 can be attached to and detached from the rotating portion 601. As a fixing method other than the method using the bolt 402, the function unit 400 may be configured to be attachable and detachable by a fitting mechanism of a mechanical mechanism. The connector 300 includes a third connector 340 on its surface that is in contact with the function unit 400, and the function unit 400 includes a fourth connector 440 at a position opposed to the third connector 340. When the function unit 400 is fixed to the connector 300, the third connector 340 and the fourth connector 440 join together. The third connector 340 and the fourth connector 440 are both Ethernet connectors. Spring connectors may be used as the third connector 340 and the fourth connector 440. However, contact parts are not limited to this example.

### (Fixed Portion 500)

The device 600 for the machine tool is provided with the fixed portion 500 including the cylindrical portion 502 and the extension 508. The cylindrical portion 502 of the fixed portion 500 supports the connector 300 to be rotatable, by a first bearing 504 and a second bearing 506. That is, the cylindrical portion 502 corresponds to a housing that accommodates therein the connector 300 that rotates, as a machine component.

The extension 508 of the fixed portion 500 is provided with a cylindrical positioning portion 510. The positioning portion 510 is fitted into a non-rotating part 110 formed in the locking block 108 of the spindle 100, serves as a guide when the device 600 is mounted, and fixes the fixed portion 500 so as not to allow rotation of the fixed portion 500. Further, the locking block 108 includes a first connector 120 on its surface that is in contact with the extension 508, and the extension 508 includes a second connector 520 at a position opposed to the first connector 120. When the positioning portion 510 is inserted into the non-rotating part 110, the first connector 120 and the second connector 520 join together. The second connector 520 receives electricity from the spindle 100. The first connector 120 and the second connector 520 are both Ethernet connectors. Spring connectors may be used as the first connector 120 and the second connector 520. However, contact parts are not limited to this example.

When the spindle 106 rotates, the rotating portion 601 (the shank portion 200 and the connector 300) and the function unit 400 rotate as one body, but the fixed portion 500 locked by the locking block 108 does not rotate.

FIG. 3 is a cross-sectional view related to wires, electrical parts, and optical parts in the device 600 for the machine tool.

### (Outline of Wires)

Ethernet cables and Ethernet connectors are used as wires for communication by the Ethernet and power feeding by PoE. The specifications of the Ethernet cables and the Ethernet connectors are defined as standards. As described above, all of the first connector 120, the second connector 520, the third connector 340, and the fourth connector 440 are Ethernet connectors and are connected to Ethernet cables. Spring connectors may be used as the first connector 120, the second connector 520, the third connector 340, and the fourth connector 440. However, contact parts are not limited to this example.

The second connector 520 in the present embodiment is a male connector provided with eight contact pins. The first connector 120 is a female connector having eight contact holes. When the device 600 for the machine tool is brought close to the spindle 100 by a tool changing device, the second connector 520 and the first connector 120 come close to each other in such a manner that the contact pins respectively fit into the contact holes. When the device 600 for the machine tool is mounted to the spindle 100, the second connector 520 and the first connector 120 are coupled together. Although an example using an eight-pin connector is described here, a connector with nine or more pins may be used, or a connector with seven or less pins may be used. Since Ethernet communication and PoE can be realized by at least four wires, a connector with four or more pins can be used. For example, a four-pin connector may be used.

In a case where the first connector 120 on the machine tool side is a female connector, foreign substances such as scrap metal are hardly caught by that connector. However, the male connector and the female connector may be reversed. That is, the second connector 520 may be a female connector having eight contact holes, and the first connector 120 may be a male connector having eight contact pins. The contact pins and the contact holes have a power terminal function and a communication terminal function.

One of the third connector 340 and the fourth connector 440 may be a male connector, and the other one may be a female connector. The number of contact pins and the number of contact holes are the same as those of the first connector 120 and the second connector 520. Further, the contact pins and the contact holes have a power terminal function and a communication terminal function.

These wires electrically connect the spindle 100 and the function unit 400 to each other. The spindle 100 is power supply equipment in PoE. The power supply equipment in PoE is referred to as PSE (Power sourcing equipment). The function unit 400 is power receiving equipment in PoE. The power receiving equipment in PoE is referred to as a “PD (Powered device)”.

An Ethernet cable 122 is connected to the first connector 120 through the locking block 108. An Ethernet cable 522 connected to the second connector 520 joined to the first connector 120 extends to the inside of the connector 300 through a wire way 524 and a cable accommodating portion 526.

### (Cable Accommodating Portion 526)

The fixed portion 500 includes the cable accommodating portion 526. The cable accommodating portion 526 is arranged in a path of a wire connecting the second connector 520 and an electrical circuit board 444 to each other. The cable accommodating portion 526 forms an annular space around a rotation axis of the rotating portion 601 in the boundary with the rotating portion 601 in the fixed portion 500. The cable accommodating portion 526 accommodates therein the Ethernet cable 522 wound a plurality of times. A margin is also given to the turns of the Ethernet cable 522. That is, a gap is provided in the cable accommodating portion 526 in such a manner that the shape of the cable 522 wound a plurality of times can be changed in accordance with a rotation angle of the rotating portion 601.

### (Winding Portion 304)

The connector 300 includes a winding portion 304 having a grasping portion 306. A middle part of the Ethernet cable 522 extending from the cable accommodating portion 526 to the inside of the connector 300 is grasped by the grasping portion 306 of the connector 300 (more specifically, is held while being grasped). The grasping portion 306 is provided inside the winding portion 304 that forms an annular space integrated with the cable accommodating portion 526, and rotates as a part of the rotating portion 601. With this configuration, the grasping portion 306 works so as to circularly move the middle part of the Ethernet cable 522. An end of the Ethernet cable 522 fixed to the grasping portion 306 passes through a wire way 324 extending forward from the winding portion 304 and is connected to the third connector 340 provided on an end surface of the connector 300.

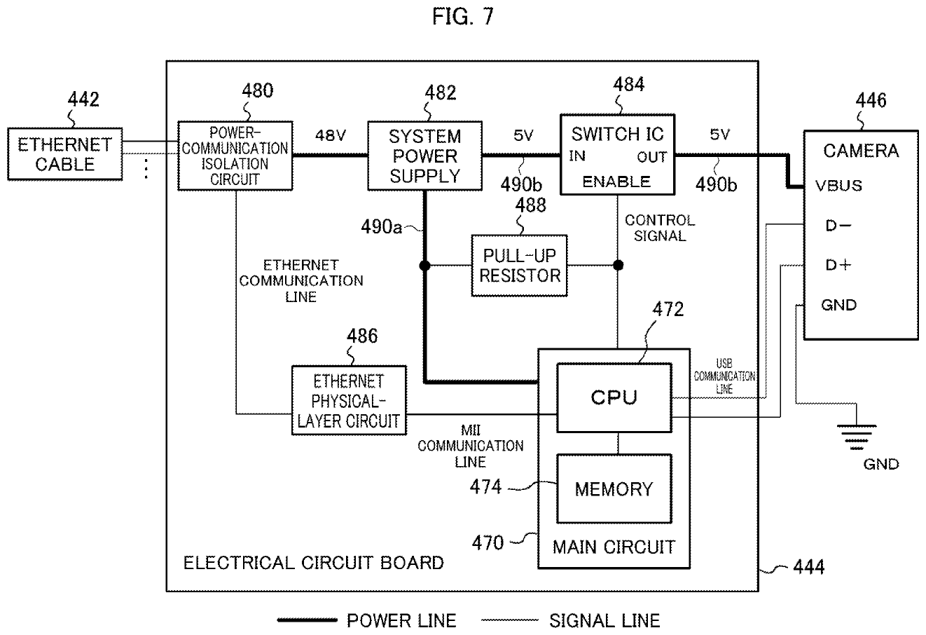

An Ethernet cable 442 connected to the fourth connector 440 joined to the third connector 340 is connected to the electrical circuit board 444 through a wire way 424. Transmission lines included in the Ethernet cable 442 are connected to a power-communication isolation circuit (see FIG. 7) in the electrical circuit board 444.

### (Optical Parts)

The function unit 400 has a camera 446 and a lens 448 as optical parts. The camera 446 includes an image sensor (for example, a CMOS) that visualizes its received light and has an image capturing function. The camera 446 is an example of a function portion among function portions having predetermined functions, which receives an instruction from an application running on an OS. The instruction from the application running on the OS will be described later. The lens 448 is, for example, a telecentric lens. A lens cover 450 is attached to an end of the function unit 400 with a bolt 452. A coaxial epi-illumination 454 and a ring illumination 456 are further provided in the functional unit 400. Either one of or both the coaxial epi-illumination 454 and the ring illumination 456 emits/emit light when image capturing is performed. The electrical circuit board 444, the camera 446, the lens 448, the coaxial epi-illumination 454, and the ring illumination 456 operate by power supplied by PoE. As described above, an example of the function unit 400 is a camera unit including an image sensor (a CMOS) and a lens.

### (Machining System)

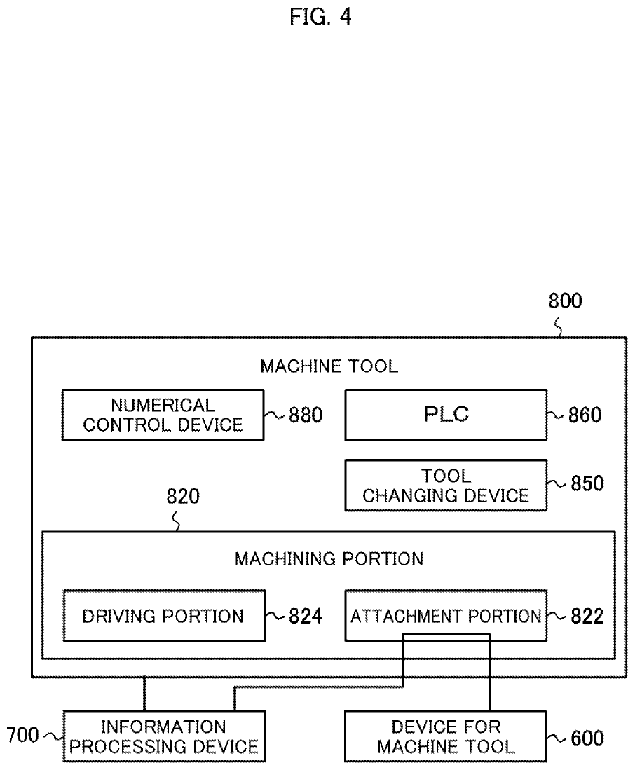

FIG. 4 is a configuration diagram of a first form of a machining system.

The configuration of a machining system using the device 600 for the machine tool is described. A machine tool 800 includes a machining portion 820, a tool changing device 850, a PLC (Programmable Logic Controller) 860, and a numerical control device 880. The machining portion 820 machines a workpiece. The machining portion 820 includes an attachment portion 822 to which a tool or the device 600 for the machine tool is attached and a driving portion 824, such as a servo motor, for rotating a shaft. In a case where the machine tool 800 is a machining center, the spindle 100 corresponds to the attachment portion 822, and a servo motor that rotates the spindle 100 corresponds to the driving portion 824. The driving portion 824 of the machining center also performs an operation of moving the attachment portion 822 (the spindle 100) to which the device 600 for the machine tool is attached. In a case where the machine tool 800 is a turning center, a turret corresponds to the attachment portion 822, and the machine tool 800 includes the driving portion 824 that moves the turret in addition to a servo motor that rotates a rotation shaft to which a workpiece is attached. The driving portion 824 of the turning center performs an operation of moving the attachment portion 822 (the turret) to which the device 600 for the machine tool is attached. The numerical control device 880 executes an NC program, thereby causing the machining portion 820 of the machine tool 800 to operate in accordance with a code specified by the NC program. The numerical control device 880 also provides an instruction to change a tool or the device 600 for the machine tool during execution of the NC program. The machining portion 820 includes a tool magazine that can accommodate therein a number of tools and devices 600 for the machine tool to be attached to the attachment portion 822.

When a tool or the device 600 for the machine tool attached to the attachment portion 822 is changed, the numerical control device 880 sends a tool change instruction to the PLC 860. Upon receiving the tool change instruction, the PLC 860 controls and causes the tool changing device 850 to replace the tool mounted to the spindle 100 with a tool accommodated in the tool magazine of the tool changing device 850 in accordance with that instruction. In this example, the device 600 for the machine tool is mounted to or removed from the attachment portion 822 by the tool changing device 850 in an identical manner to the tool.

An information processing device 700 is connected to the machine tool 800 via a communication line. Further, the information processing device 700 can communicate with the device 600 for the machine tool. In a case of performing wired communication, the information processing device 700 and the device 600 for the machine tool are connected to each other by a communication line that passes inside the attachment portion 822. Wireless communication using a wireless LAN or the like may be performed between the information processing device 700 and the device 600 for the machine tool. A captured image from the device 600 for the machine tool is transmitted from the attachment portion 822 to the information processing device 700 by wired communication. Alternatively, the captured image from the device 600 for the machine tool may be transmitted to the information processing device 700 by wireless communication.

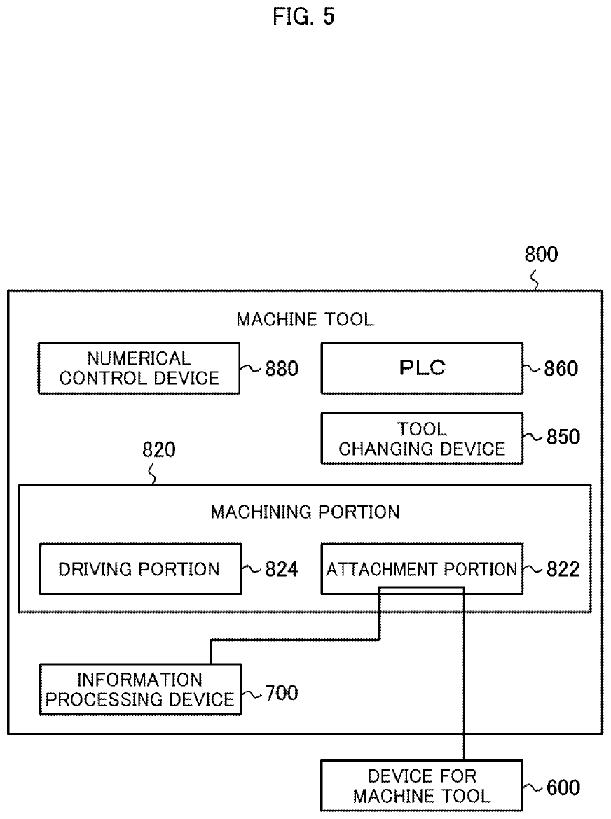

FIG. 5 is a configuration diagram of a second form of the machining system.

The information processing device 700 may be provided inside the machine tool 800. The information processing device 700 may be a console attached to the machine tool 800.

### (Startup Time of Device 600 for Machine Tool)

The device 600 for the machine tool receives power supply and starts a startup operation after being mounted to the attachment portion 822. For example, in a case of automatically mounting the device 600 for the machine tool by the tool changing device 850 or a case of manually mounting the device 600 for the machine tool in order to capture an image of the machining result of a workpiece and perform measurement, it is desired that a cycle time of image capturing and measurement is shortened as much as possible by shortening a time required for startup of the device 600 for the machine tool.

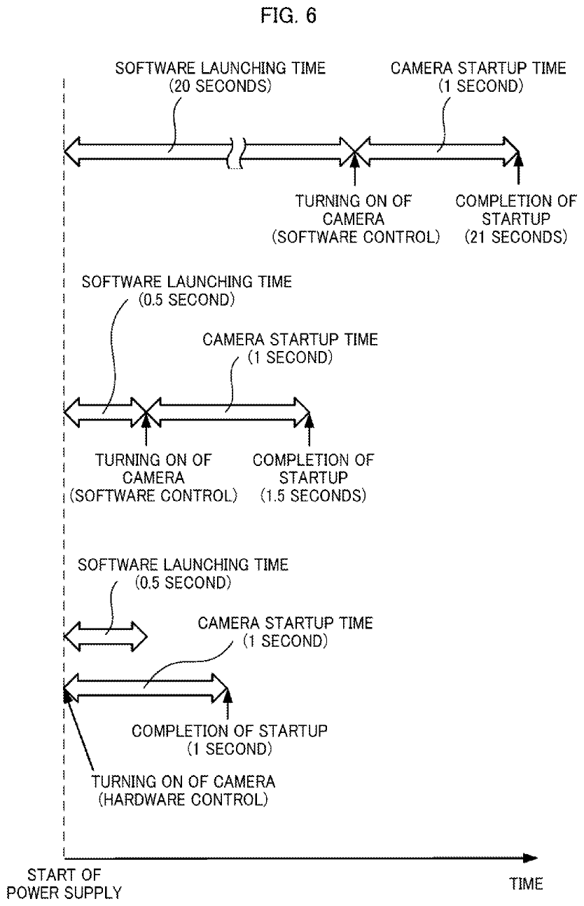

FIG. 6 is a diagram illustrating an outline of a time required for startup of the device 600 for the machine tool.

The startup time of the device 600 for the machine tool includes a time of launching software that is run by a CPU and a startup time of the camera 446. In a conventional method, after software is launched, the camera 446 is turned on by software control, so that the camera 446 is started up. This is because a concept of controlling the power of the camera 446 by the software is basically employed. By controlling the power of the camera 446 by the software, the camera 446 can be turned off while being not used, and therefore power consumption can be reduced. In addition, if malfunction of the camera 446 occurs, the camera 446 can be recovered by being turned off once and started up again.

A startup time in the conventional method is illustrated in the upper part of FIG. 6. First, software is launched. Most of a software launching time is a time of booting an OS. In a case where the OS is Linux (registered trademark), for example, it takes about 20 seconds to launch the software. Thereafter, the software controls the camera 446 and turns on the camera 446, so that the camera 446 is started up. Startup of the camera 446 starts about 20 seconds after start of power supply. It takes about one second from turning on of the camera 446 until completion of startup of the camera 446. Therefore, a startup time of the device 600 for the machine tool is about 21 seconds as a whole.

Two proposals for improvement are made in order to shorten the startup time of the device 600 for the machine tool. The first proposal is to adopt a real-time OS. Although the real-time OS has limited functions as compared with a versatile OS, such as Linux, the program size is smaller and a boot time is shorter accordingly. With the real-time OS, the boot time can be shortened to about 0.5 second. A possible example of the real-time OS is ITRON (Industrial TRON). The real-time OS employs a method of assigning an operating time to a task in accordance with the priority of the task. The versatile OS employs a round robin method and is different from the real-time OS in the manner of assigning a time to a task. As illustrated in the middle part of FIG. 6, when the real-time OS is used, launching of the software only takes about 0.5 second, so that the camera 446 can be started up 0.5 second after the start of power supply. The startup time of the device 600 for the machine tool is shortened to about 1.5 seconds as a whole.

The second proposal for improvement is to turn on and start up the camera 446 by hardware control. The camera 446 has a mechanism for automatically starting startup upon receiving a predetermined level of power. Therefore, without an instruction from software, the camera 446 can start startup only by being turned on. As illustrated in the lower part of FIG. 6, while a CPU launches software, the camera 446 is started up in parallel. This configuration enables the camera 446 to be started from the time of start of power supply. The startup time of the device 600 for the machine tool is shortened to about one second as a whole. The camera 446 can start startup without waiting for completion of launching of the software. A mechanism is also provided which enables the power of the camera 446 to be controlled by the software after the software is launched. That is, a function of controlling the power of the camera 446 by the software is also provided.

### (Configuration of Electrical Circuit Board 444)

FIG. 7 is a configuration diagram of the electrical circuit board 444.

In FIG. 7, a power line that allows a power-supply current to flow is illustrated with thick lines, and a signal line that allows a signal current for communication to flow is illustrated with thin lines. A power-communication isolation circuit 480 is coupled to the Ethernet cable 442. The number of conducting wires included in the Ethernet cable 442 is coincident with the number of pins in the above-described Ethernet connector. Although the number of conducting wires is eight in this example, the number may be nine or more or seven or less. For example, the number of conducting wires may be four. The power-communication isolation circuit 480 isolates a power-supply current and a signal current for Ethernet communication in accordance with the PoE standards. The power-communication isolation circuit 480 is also called a PD module.

A 48-V power-supply current is supplied to a system power supply 482. The system power supply 482 is a voltage conversion circuit that performs voltage conversion in accordance with an electrical circuit or an electrical device using power. In this example, the system power supply 482 supplies a current serving as the power of a main circuit 470 and a current serving as the power of the camera 446. The power of the main circuit 470 serves as the power of a CPU 472. The power of the camera 446 is 5 V. As described above, the system power supply 482 sends power toward the CPU 472 that is an example of a processor and the camera 446 that is an example of a function portion.

A USB (Universal Serial Bus) is used as a transmission interface of the camera 446. The current serving as the power of the camera 446 flows to a VBUS terminal (a power terminal) of the camera 446 via a switch IC 484. The switch IC 484 operates as a switch that allows a 5-V power-supply current to pass therethrough or disconnects it. When a control signal input to an ENABLE terminal is High, the switch IC 484 is turned on and connects its IN terminal and its OUT terminal to each other, thereby allowing the power-supply current to pass therethrough. On the other hand, when the control signal input to the ENABLE terminal is Low, the switch IC 484 is turned off and does not connect the IN terminal and the OUT terminal to each other, thereby cutting off the power-supply current. Upon detection of a voltage of 5 V by the power-supply current at the VBUS terminal, the camera 446 automatically starts a startup operation. That is, a function portion exemplified by the camera 446 starts its startup operation upon receiving power. A GND terminal of the camera 446 obtains a reference potential. The camera 446 is an example of a function portion that receives an instruction from an application running on an OS among function portions having predetermined functions. Specifically, the camera 446 has an image capturing function. Further, the camera 446 captures an image of a workpiece or the like in response to an image capturing instruction from the application running on the OS.

A signal for Ethernet communication sent out from the power-communication isolation circuit 480 is transmitted to the CPU 472 as an MII signal via an Ethernet physical-layer circuit 486. A signal output from the CPU 472 to an external device (e.g., the information processing device 700) is also transmitted from the power-communication isolation circuit 480 via the Ethernet physical-layer circuit 486 in the reverse direction. That is, the CPU 472 can perform two-way communication with the external device (e.g., the information processing device 700) by the power-communication isolation circuit 480 and the Ethernet physical-layer circuit 486.

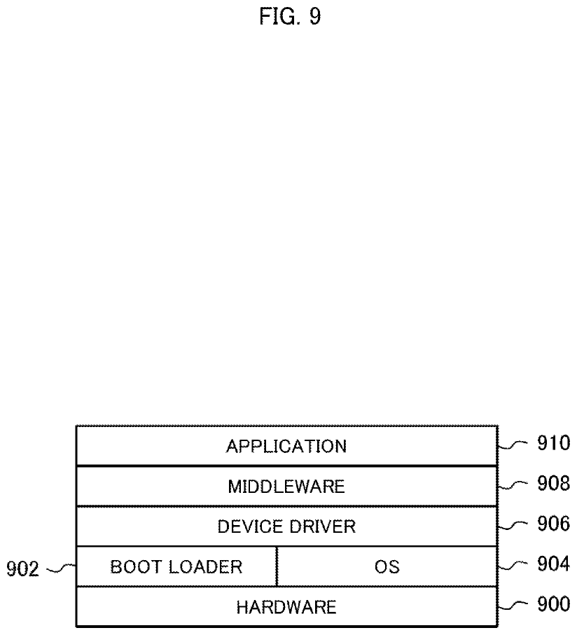

The main circuit 470 includes the CPU 472 and a memory 474. The memory 474 includes a non-volatile memory region using, for example, a ROM (Read Only Memory) and a volatile memory region using, for example, a RAM (Random Access Memory). The CPU 472 executes software stored in the non-volatile memory region of the memory 474 (hereinafter, “embedded programs”). The embedded programs will be described later with reference to FIG. 9. When the power of the main circuit 470 is obtained, the CPU 472 performs a process of launching software stored in the memory 474. When the power is supplied to the main circuit 470 and the process of launching the software is performed, power supply to the camera 446 is performed at the same time. That is, the system power supply 482 supplies power to the function portion (the camera 446) in parallel to the process of booting the OS (the real-time OS).

The CPU 472 is connected to the camera 446 via signal lines D− and D+. The CPU 472 sends an instruction to perform image capturing or the like to the camera 446 and receives data of a captured image from the camera 446, using the signal lines D− and D+. The data of the captured image is temporarily saved in the memory 474 and is sent to the external device (e.g., the information processing device 700) via the Ethernet physical-layer circuit 486 and the power-communication isolation circuit 480.

A flow of power and a flow of a signal are described below, following operations on a step-by-step basis.

(Immediately after Power is Turned on)

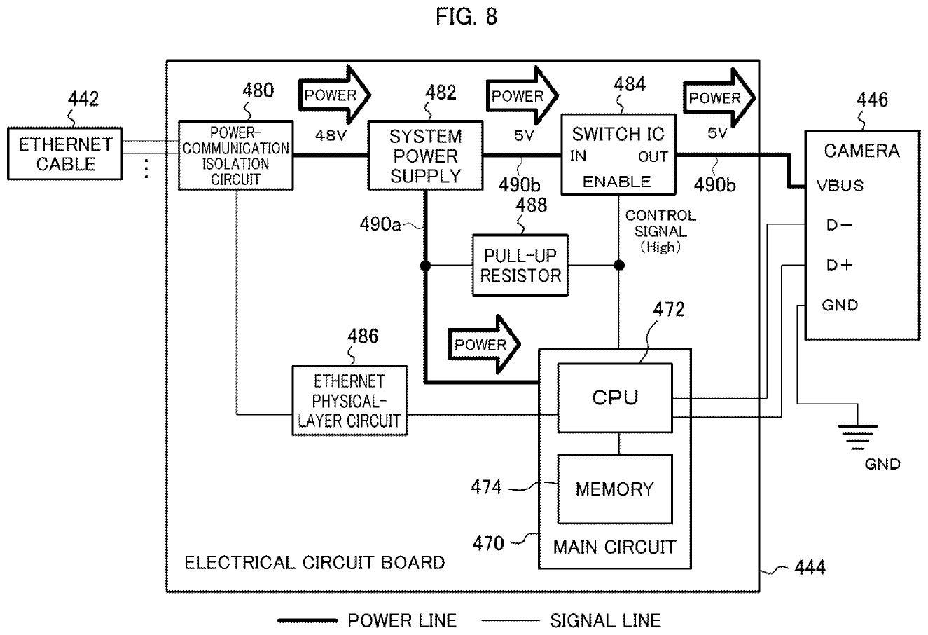

FIG. 8 is a diagram illustrating a flow of power immediately after a power is turned on. When the device 600 for the machine tool is mounted to the attachment portion 822 and obtains power, a system power supply is turned on. Specifically, the system power supply 482 receives power from the power-communication isolation circuit 480 and supplies power for the camera 446 and power for the main circuit 470. When the power for the main circuit 470 is supplied, the CPU 472 starts to launch software. That is, a processor exemplified by the CPU 472 performs a process of booting an OS (a real-time OS) upon receiving the power from the system power supply 482.

At this step, the CPU 472 does not issue a control signal to the ENABLE terminal of the switch IC 484. By an action of a pull-up resistor 488, a High control signal is input to the ENABLE terminal. Therefore, the switch IC 484 is turned on, and a power-supply current for the camera 446 input to the IN terminal of the switch IC 484 is output from the OUT terminal and input to the VBUS terminal of the camera 446. The camera 446 then starts startup automatically. That is, the system power supply 482 supplies the power to the camera 446 (an example of a function portion) in parallel to the process of booting the OS (the real-time OS), and the camera 446 (an example of a function portion) starts its startup operation upon receiving power.

### (Embedded Programs)

FIG. 9 is a configuration diagram of embedded programs.

The embedded programs that become executable by launching of software are described. The embedded programs are stored in the memory 474 and executed in the CPU 472. A boot loader 902, an OS 904, a device driver 906, middleware 908, and an application 910, which are higher than the lowest-level hardware 900, correspond to the embedded programs. All of the embedded programs are stored in a non-volatile memory region of the memory 474. Therefore, the embedded programs are retained without power.

When the CPU 472 boots the OS 904, processing by the boot loader 902 is performed. The boot loader 902 loads the OS 904 to a volatile memory region of the memory 474. The OS 904 is, for example, a real-time OS such as ITRON. The device driver 906 is also loaded to the volatile memory region of the memory 474 together with the OS 904. Examples of the device driver 906 include a USB driver, a LAN driver, and an UART (Universal Asynchronous Receiver/Transmitter) driver. When booting of the OS 904 is completed, execution of the middleware 908 and the application 910 becomes possible. The middleware 908 is launched after completion of booting of the OS 904, and is loaded to the volatile memory region of the memory 474. Examples of the middleware 908 include control software of TCP (Transmission Control Protocol)/IP (Internet Protocol) and a Web server/client function module. Further, the application 910 is also launched and loaded to the volatile memory region of the memory 474. The application 910 is an agent of remote image capturing that is resident, for example. The application 910 operates in cooperation with the OS 904, the device driver 906, and the middleware 908.

The application 910 receives a command from an external device (e.g., the information processing device 700) and performs processing. The application 910 mainly performs an image capturing process and an image transmission process. Since image capturing is performed by a remote operation, a shutter operation is not necessary unlike a general digital camera. Further, unlike the general digital camera, a captured image is transmitted to the external device (e.g., the information processing device 700). The information processing device 700 can obtain a captured image of a workpiece or chips by using the function of remote image capturing by the application 910. With these embedded programs, high-speed startup, high reliability, security measures, scalability, and the like are realized.

### (After Launching of Software)

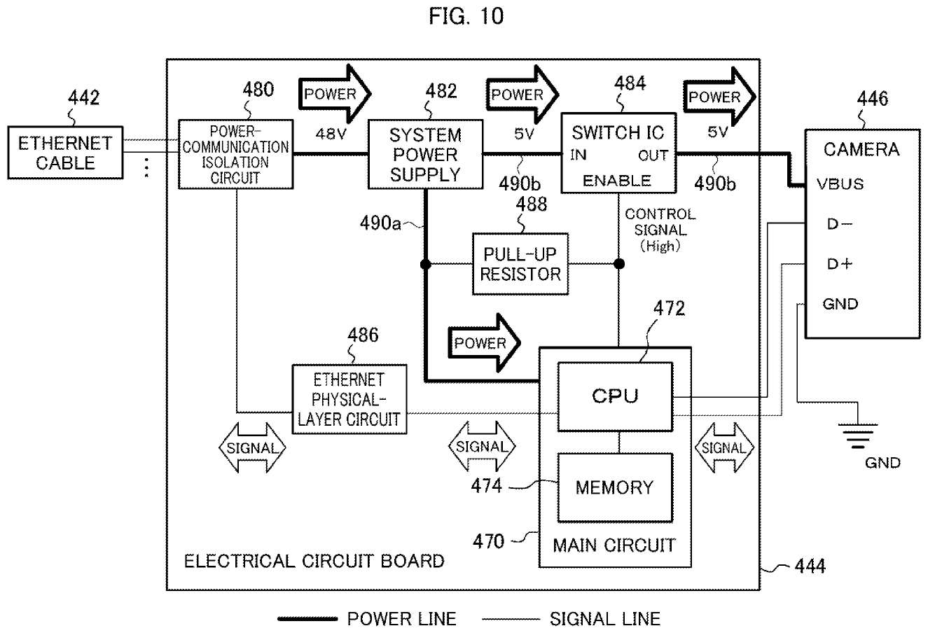

FIG. 10 is a diagram illustrating a flow of power and a flow of a signal after launching of software.

When launching of software is completed, operations of embedded programs become possible. With processing by the application 910, the CPU 472 is placed in a state where it can communicate with the information processing device 700 and the camera 446. When receiving an image capturing command from the information processing device 700, the CPU 472 instructs the camera 446 to perform image capturing with processing by the application 910. When the image capturing instruction is sent to the camera 446 (an example of a function portion) having an image capturing function as a predetermined function from the application 910 running on the OS 904, the camera 446 performs image capturing in response to the image capturing instruction. The CPU 472 acquires captured image data from the camera 446 and saves the data in the memory 474 with processing by the application 910. The CPU 472 then transmits the captured image data to the external device (e.g., the information processing device 700) with processing by the application 910. At this time, when the camera 446 normally operates, the CPU 472 does not manipulate a control signal to the ENABLE terminal of the switch IC 484. Therefore, power supply to the camera 446 is continued while the control signal to the ENABLE terminal is kept High due to the action of the pull-up resistor 488.

### (Stop of Power Supply to Camera)

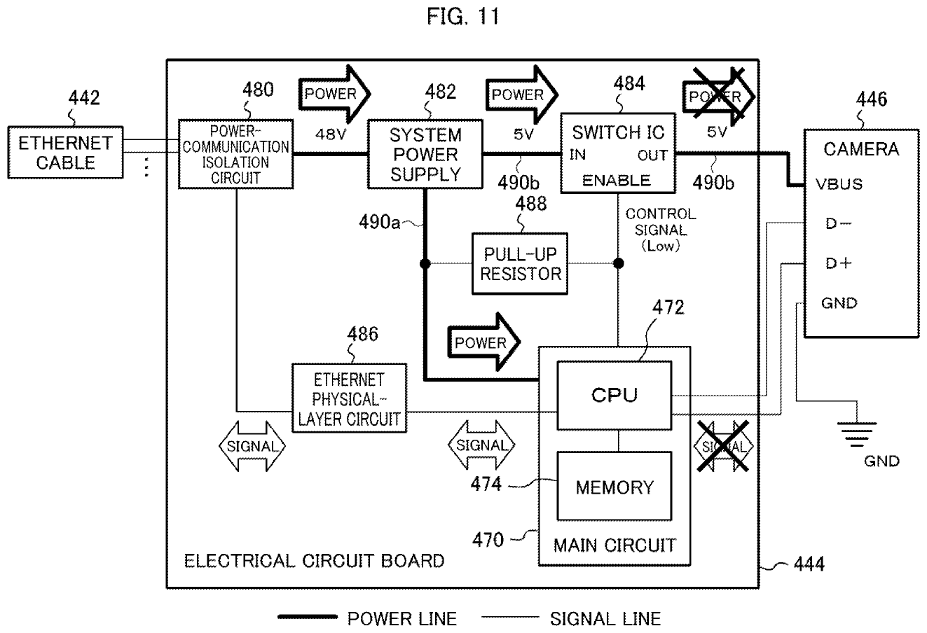

FIG. 11 is a diagram illustrating a flow of power and a flow of a signal when power supply to a camera is stopped.

In a case where the camera 446 does not operate normally, for example, the camera no longer responds, the CPU 472 turns off the camera 446 once due to processing by the application 910. That is, power supply to the camera 446 is stopped. Specifically, the CPU 472 sends a Low control signal to the ENABLE terminal of the switch IC 484. Accordingly, the switch IC 484 is turned off, so that a power-supply current to the camera 446 no longer flows.

After waiting for a few seconds after turning off the camera 446, the CPU 472 resumes power supply to the camera 446 with processing by the application 910. Specifically, the CPU 472 sends a High control signal to the ENABLE terminal of the switch IC 484. Accordingly, the switch IC 484 is turned on, so that the power-supply current to the camera 446 flows. The camera 446 (an example of a function portion) starts its startup operation upon receiving the power. By restarting the camera 446 in this manner by turning on the power again, the camera 446 can be recovered so as to operate normally.

As described above, since a waiting time such as a startup time can be shortened, energy to be used during that time is reduced, and energy is saved.

### <First Modification>

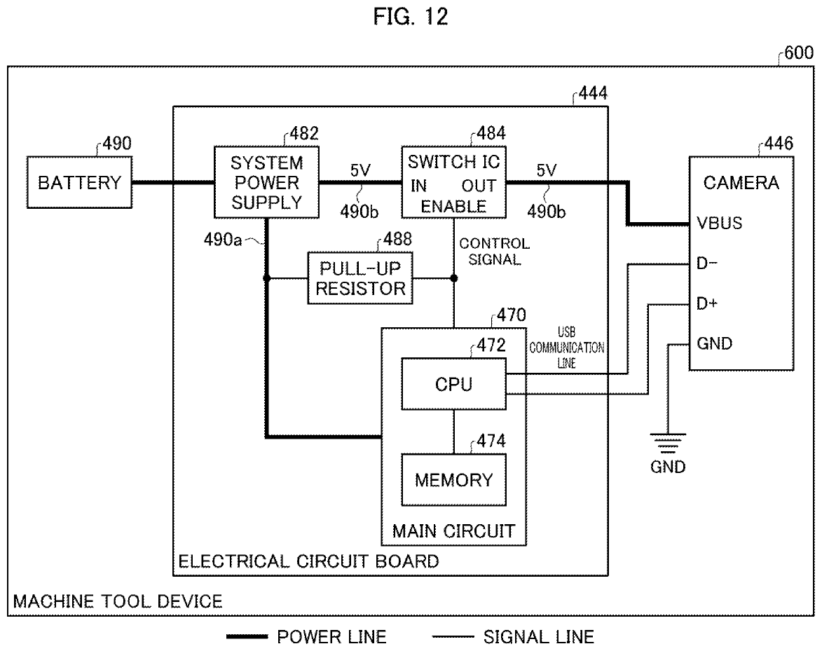

FIG. 12 is a configuration diagram of the electrical circuit board 444 according to a first modification.

Although an example in which power is obtained from outside via an Ethernet cable has been described in the embodiment, power of a battery 490 may be used. The device 600 for the machine tool includes the battery 490 connected to the system power supply 482. The system power supply 482 converts a voltage obtained from the battery 490 to generate a power-supply voltage for the camera 446 and a power-supply voltage for the main circuit 470. The system power supply 482 sends power toward the CPU 472 (an example of a processor) and the camera 446 (an example of a function portion).

The CPU 472 (an example of a processor) performs a process of booting an OS (a real-time OS) upon receiving the power from the system power supply 482, as in the embodiment. The system power supply 482 supplies the power to the camera 446 (an example of a function portion) in parallel to the process of booting the OS (the real-time OS), and the camera 446 starts its startup operation upon receiving the power. As described above, the device 600 for the machine tool includes the camera 446, the battery 490, and the electrical circuit bard 444. It suffices that the battery 490 is installed in any space inside the device 600 for the machine tool. In particular, when the battery 490 is mounted inside the function unit 400, complicated wiring is no longer necessary. In FIG. 3, for example, the battery 490 is installed in an empty space in the back or front of the lens 448 so as not to interfere with the coaxial epi-illumination 454 and the electrical circuit board 444. The size increase of the device can be prevented by arranging the battery 490 in the empty space.

### <Second Modification>

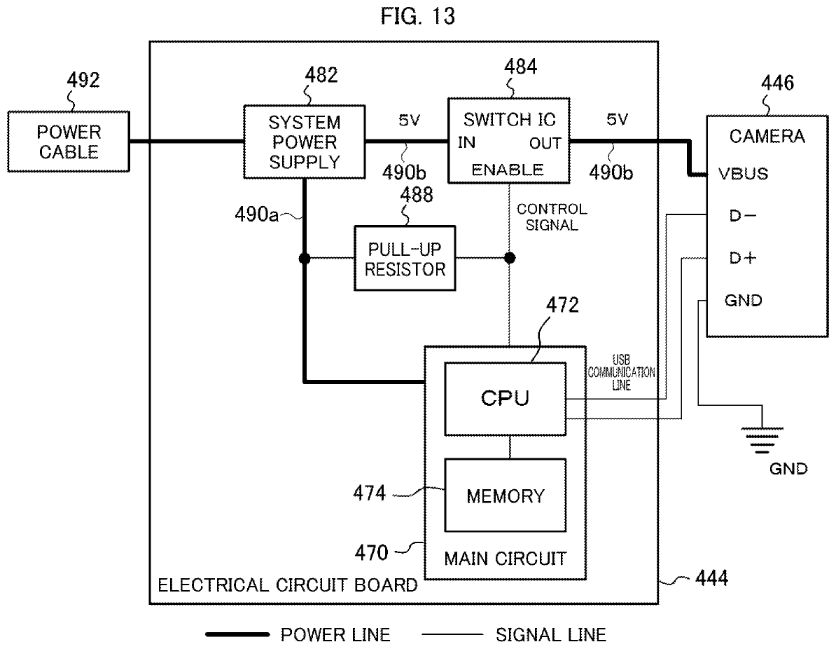

FIG. 13 is a configuration diagram of the electrical circuit board 444 according to a second modification.

Power may be obtained from an external power supply by using a power cable 492 and a power connector, in place of Ethernet cables and Ethernet connectors (the first connector 120 to the fourth connector 440) in the embodiment. The system power supply 482 of the device 600 for the machine tool is connected to the power cable 492. The system power supply 482 converts a voltage obtained from an external power supply via the power cable 492 and the power connector to generate a power-supply voltage for the camera 446 and a power-supply voltage for the main circuit 470. In a case where the external power supply is an alternating-current power supply, the system power supply 482 converts the alternating current input thereto to a direct current and outputs the direct current. The system power supply 482 sends power toward the CPU 472 (an example of a processor) and the camera 446 (an example of a function portion).

The CPU 472 (an example of a processor) performs a process of booting an OS (a real-time OS) upon receiving the power from the system power supply 482, as in the embodiment. The system power supply 482 supplies power to the camera 446 (an example of a function portion) in parallel to the process of booting the OS (the real-time OS), and the camera 446 starts its startup operation upon receiving the power.

### <Power Lines of a Plurality of Systems>

A power line 490a illustrated in FIGS. 7, 8, and 10 to 13 supplies power from the system power supply 482 to the processor (e.g., the CPU 472 (the main circuit 470)). Similarly, a power line 490b supplies power from the system power supply 482 to the function portion (e.g., the camera 446) via the switch IC 484.

The system power supply 482 sends power to the CPU 472 via the power line 490a (e.g., first electrical wire). When receiving the power from the system power supply 482, the CPU 472 performs a process of booting the OS 904 (operating system). The system power supply 482 also supplies power to the camera 446 via the power line 490b (e.g., second electrical wire) to the process of booting the OS 904. The camera 446 starts its startup operation upon receiving the power from the system power supply 482. When booting of the OS 904 is completed, the application 910 is launched. When (i) the process of launching software including the OS 904 and the application 910 and (ii) the startup operation of the camera 446 are completed, the camera 446 receives an instruction from the application 910 running on the OS 904 through communication lines D− and D+.

As described above, the power line 490a and the power line 490b are connected to a plurality of systems respectively. Power can be supplied from the system power supply 482 to the CPU 472 via the power line 490a, and can be supplied to the camera 446 from the system power supply 482 via the power line 490b at the same time. Since the power lines of a plurality of systems such as the power line 490a and the power line 490b are provided, the camera 446 can be started up regardless of whether the application (or software) is launched (or the OS is launched). That is, the system power supply 482 supplies the power from the power line 490a to the CPU 472 and also supplies the power to the function unit (e.g., function portion, the camera 446) via the power line 490b, whereby the function unit can start its startup operation at the time when it receives power supply, without depending on whether the application (or software) is launched. With this configuration, the camera 446 can be started up even after booting of the OS 904 by the CPU 472 is started or during launching of software including the OS 904 and the application 910. Consequently, a required time for system startup can be shortened.

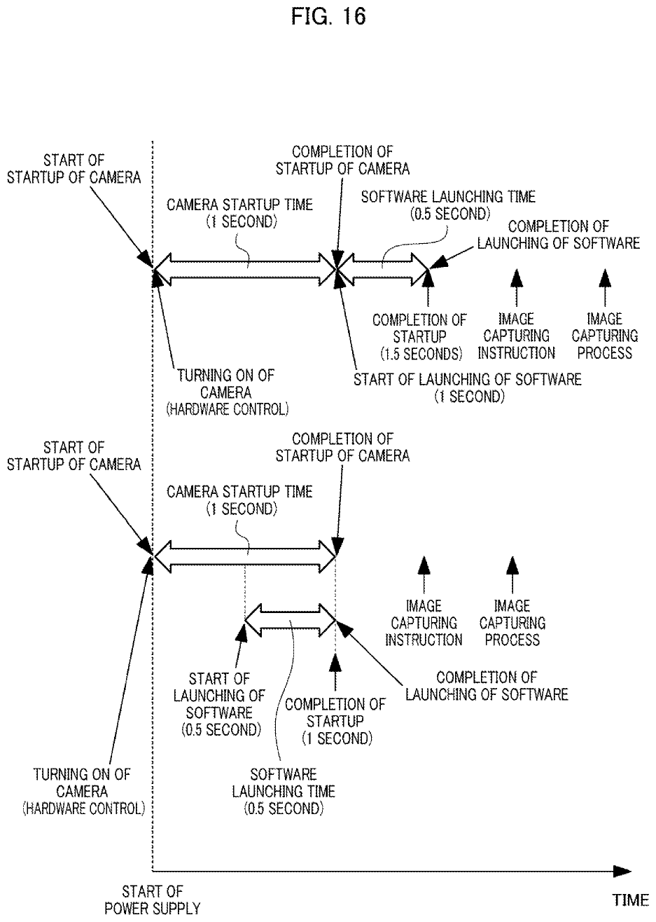

FIG. 16 is a diagram illustrating another example of a procedure for starting up the device 600 for the machine tool.

The upper part of FIG. 16 illustrates a sequence in a case of launching software including the OS 904 and the application 910 on the condition that startup of the camera 446 is completed. The lower part of FIG. 16 illustrates a sequence in a case of launching the software including the OS 904 and the application 910 before completion of startup of the camera 446. In the sequence in the lower part of FIG. 16, launching of the software is started with a slight delay from the start timing of startup of the camera 446, unlike the sequence in the lower part of FIG. 6. Further, the description is provided assuming that a startup time of the camera 446 is 1.0 second and a software launching time is 0.5 second as in FIG. 6.

In the example illustrated in the upper part of FIG. 16, the system power supply 482 supplies power to the camera 446 first. The camera 446 that has been turned on starts startup, and the system power supply 482 starts power supply to the CPU 472 at the time of completion of startup of the camera 446, that is, 1.0 second after the start of startup. Since the startup time of the camera 446 is 1.0 second and the software launching time is 0.5 second, a time required for startup completion of both of them is 1.5 seconds. Thereafter, the camera 446 performs an image capturing process in response to an image capturing instruction.

Also in the example illustrated in the lower part of FIG. 16, the system power supply 482 only starts power supply to the camera 446 first. The system power supply 482 starts power supply to the CPU 472 at the time when 0.5 second has passed from the start of power supply to the camera 446, that is, before completion of startup of the camera 446. Since launching of the software takes 0.5 second, launching of the software is completed at the same timing as completion of the startup of the camera 446. The total startup time is 1.0 second. Thereafter, the camera 446 performs an image capturing process in response to an image capturing instruction. As described above, according to a method of supplying power from each of power lines of a plurality of systems separately, a completion time of startup of the camera 446 and a completion time of launching of the software can be made coincident with each other by making timings of power supply to the camera 446 and the CPU 472 different from each other. For example, the battery 490 described in the first modification starts power supply to the camera 446 in such a manner that the camera 446 can be started up between start of launching of software in the CPU 472 and completion of launching. If startup of the camera 446 has been completed at the time of completion of launching of the software, the application 910 can immediately issue an image capturing instruction to the camera 446, and the camera 446 can perform an image capturing process in response to that instruction.

### <Other Modifications>

A function portion may be a device other than the camera 446, for example, a laser scanner or a microphone. Further, a transmission interface for communication and power in the function portion may be a transmission interface other than USB.

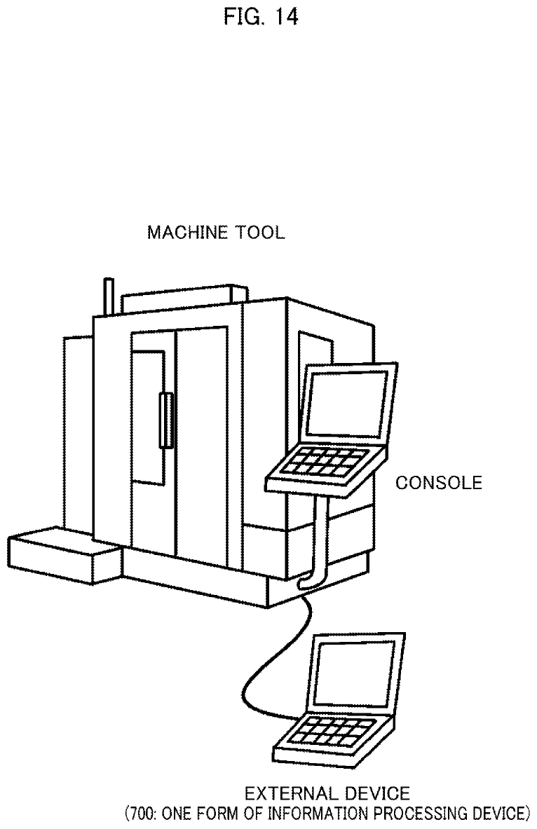

FIG. 14 is an external view of a machine tool.

The machine tool has a door that can be open and closed on its front side. FIG. 14 illustrates a state where the door is open. The machine tool includes a console. An external device (one form of the information processing device 700) is connected to the machine tool. The information processing device 700 is not limited to a mode of the illustrated external device. The console may also serve as the information processing device 700. The form in which the external device (one form of the information processing device 700) is connected to the machine tool is merely an example. A form may be employed in which functions of the information processing device 700 are included in the machine tool.

A tool can be changed by opening the door. There is a way of using in which an image of a workpiece can be captured by an image capturing device during machining, and an edge or a surface of the workpiece is extracted as a feature point from the captured image. For example, machining may be temporarily stopped while the door is closed, and an image of the workpiece may be captured by the image capturing device without opening the door. Further, it is possible to correct a correction value for a tool on the console without opening the door afterwards and to resume machining. In addition, on the console, not only the correction value for the tool can be corrected, but also the number of revolutions of the tool or the like can be changed.

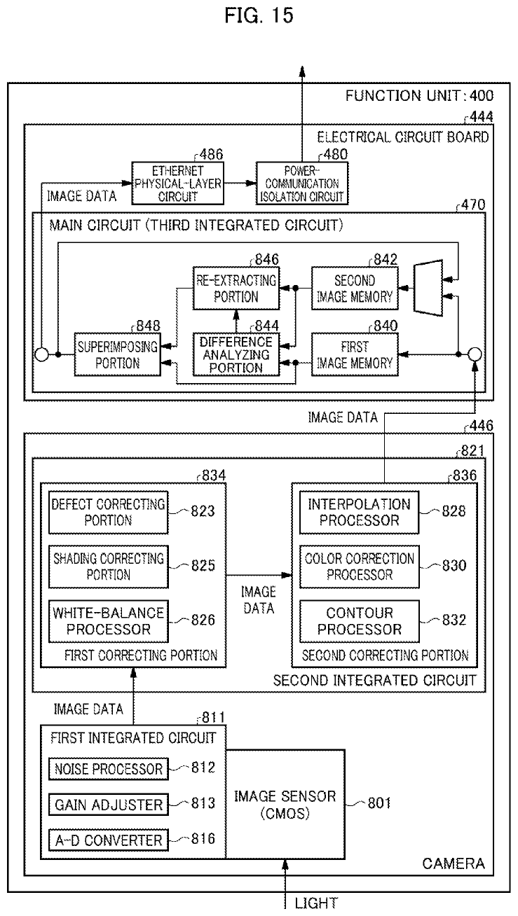

FIG. 15 is a configuration diagram of integrated circuits in the function unit 400. In this example, three integrated circuits are included in the function unit 400.

The camera 446 includes an image sensor 801 (e.g., a CMOS), a first integrated circuit 811, and a second integrated circuit 821.

The first integrated circuit 811 includes a noise processor 812, a gain adjuster 813, and an A-D converter 816. The first integrated circuit 811 is a circuit for processing noise of a signal from the image sensor 801. The noise processor 812 removes noise contained in an image obtained from the image sensor 801. The gain adjuster 813 adjusts an amplification factor (a gain) related to the current converted from light with which the image sensor 801 is exposed. The A-D convertor 816 converts analog image data to digital image data. The noise processor 812, the gain adjuster 813, and the A-D converter 816 may use known techniques. An electrical signal processed by the noise processor 812, the gain adjuster 813, and the A-D converter 816 is sent to the second integrated circuit 821. The first integrated circuit 811 may include a processor other than the noise processor 812, the gain adjuster 813, and the A-D converter 816.

The second integrated circuit 821 includes a first correcting portion 834 and a second correcting portion 836. The first correcting portion 834 includes a defect correcting portion 823, a shading correcting portion 825, and a white-balance processor 826. The second correcting portion 836 includes an interpolation processor 828, a color correction processor 830, and a contour processor 832. The defect correcting portion 823 corrects a black defect and a white defect in an image. The shading correcting portion 825 performs correction of a phenomenon that a signal output is reduced in a peripheral portion of the image (shading). The white-balance processor 826 performs correction of making the spectral characteristics of the image sensor 801 match the human luminosity factor. The defect correcting portion 823, the shading correcting portion 825, and the white-balance processor 826 may use known techniques. An electrical signal processed by the defect correcting portion 823, the shading correcting portion 825, and the white-balance processor 826 is sent to the interpolation processor 828.

The interpolation processor 828 generates RGB output data (bitmap data) that is a general video signal, from signals of an RGB Bayer arrangement by color filters of the image sensor 801. The color correction processor 830 performs correction that makes the spectral characteristics of the color filters of the image sensor 801 close to ideal characteristics. The contour processor 832 performs processing of making the contour of a subject sharp. The interpolation processor 828, the color correction processor 830, and the contour processor 832 may use known techniques. An electrical signal processed by the second integrated circuit 821 is output from the camera 446 and input to the main circuit 470 of the electrical circuit board 444. The image sensor 801, the first integrated circuit 811, and the second integrated circuit 821 may be configured as an SoC (System on Chip). The second integrated circuit 821 may include a processor other than the defect correcting portion 823, the shading correcting portion 825, the white-balance processor 826, the interpolation processor 828, the color correction processor 830, and the contour processor 832.

The main circuit 470 may include a third integrated circuit that is not included in the camera 446. A digital circuit illustrated in FIG. 15 is an example of the third integrated circuit. The third integrated circuit is a circuit for performing an analyzing process on image data processed by the camera 446. As described above, the function unit 400 includes the third integrated circuit that performs the analyzing process on the image data, separately from the general camera 446. Functions equivalent to the processors of the illustrated digital circuit may be implemented by execution of a program stored in the memory 474 by the CPU 472. Processing in the third integrated circuit is any processing. In this example, it is assumed that the third integrated circuit acquires a plurality of images instantly by one shutter operation and performs digital processing using the plural images. For example, a noise reduction process can be performed by averaging a plurality of images obtained by continuous shooting at different ISO sensitivities. Alternatively, a process of enlarging a dynamic range can be performed using a plurality of images obtained by continuous shooting with different exposures. The dynamic range is a ratio of the maximum value and the minimum value of a processable signal, and means an acceptable brightness range of the image sensor 801 here. That is, by the digital processing in the third integrated circuit, an image having a brightness difference wider than the range of brightness originally accepted by the image sensor 801 is made easy to see.

An example of performing the process of enlarging the dynamic range in the main circuit 470 is described below. Specifically, by partially superimposing two pieces of image data obtained by continuous shooting, overexposure or underexposure is canceled. The main circuit 470 includes a first image memory 840, a second image memory 842, a difference analyzing portion 844, a re-extracting portion 846, and a superimposing portion 848. The first image memory 840 stores therein first image data that is used as a basis. The second image memory 842 stores therein second image data that is referred to. The second image data is image data captured a moment before capturing of the first image data, for example. The difference analyzing portion 844 analyzes a difference between the first image data and the second image data (a motion of an image) and specifies an image region of the second image data which is to be superimposed on the first image data. The re-extracting portion 846 extracts a partial image from the second image data which is to be superimposed on the first image data. The superimposing portion 848 superimposes the partial image extracted from the second image data on the first image data. As a result, it is possible to superimpose an image obtained with appropriate exposure in the second image data on a portion in which exposure is not appropriate (an overexposed or underexposed portion) in the first image data, thereby generating an image without exposure failure as a whole. The image data processed by digital processing in the main circuit 470 is then transmitted via the Ethernet physical-layer circuit 486 and the power-communication isolation circuit 480.

The present invention is not limited to the embodiments described above and modifications thereof, and any component thereof can be modified and embodied without departing from the scope of the invention. Components described in the embodiments and modifications can be combined as appropriate to form various embodiments. Some components may be omitted from the components presented in the embodiments and modifications.

This application claims priority to Japanese Patent Application No. 2021-158848 filed on Sep. 29, 2021, which is incorporated herein by reference in its entirety.

1. A device for a machine tool, attachable to an attachment portion of a machine tool, comprising:
a processor for performing a process of booting an OS;
a function portion for receiving an instruction from an application running on the OS; and
a system power supply for sending power toward the processor and the function portion.

2. The device for the machine tool according to claim 1, wherein the OS is a real-time OS, and
the processor performs a process of booting the real-time OS upon receiving the power from the system power supply.

3. The device for the machine tool according to claim 2, wherein the system power supply supplies the power to the function portion in parallel to the process of booting the real-time OS, and
the function portion starts a startup operation upon receiving the power.

4. A device for a machine tool, attachable to an attachment portion of a machine tool, comprising:
a processor for performing a process of launching software including an OS and an application;
a function portion, having a predetermined function, for fulfilling the predetermined function when receiving an instruction from the application running on the OS; and
a battery for supplying power to the processor and the function portion, wherein
the function portion receives supply of the power from the battery so as to be started up between start of launching of the software and completion of the launching.
